(19) United States
(12) Patent Application Publication
(10) Pub. No.: US 2006/0161941 A1
(43) Pub. Date: Jul. 20, 2006

(54) Digital audio signal player

(76) Inventor: Chiu-Hsiung Liu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/034,815

(22) Filed: Jan. 14, 2005

(51) Int. Cl. G11B 17/028; G11B 17/03; G11B 19/20

(52) U.S. Cl. 720/695

(57) ABSTRACT

A digital audio signal player a turntable unit, an actuating unit for the turntable unit, a circuit board arranged under the turntable unit, a magnet on an edge of a bottom of the turntable unit, an annular magnetism sensing plate on an upper side of the circuit board to face and sense the magnet, a light blocking plate secured on a shaft of the actuating unit, and a photointerrupters to sense the light blocking plate; thus, the magnet and the blocking plate will turn when the turntable unit is turned; the turning speed of the turntable unit is acquired by means of the magnetism sensing plate and the induction magnet while the turntable unit's turning direction is acquired by means of the photointerrupters and the light blocking plate; the turntable unit's turning speed can also be acquired by means of a light sensing plate and a reflection sensor instead.

### BACKGROUND OF THE INVENTION

1. Field of the Invention

The present invention relates to a digital audio signal player, more particularly one, which is equipped with a magnetism sensing (or reflection sensing) mechanism and a photo-interruption sensing mechanism, respectively used for acquiring the turning speed and the turning direction of a turntable unit of the digital audio signal player.

2. Brief Description of the Prior Art

In order to help increase hot and exciting atmosphere in a concert or a party such as is held in a PUB or a dancing hall, the DJ usually makes the music played with special effects by means of moving the analogue vinyl record positioned on the turntable manually at changing speeds and in alternate directions. As soon as the DJ stops moving the record with his hands, the record player will start playing the record in the normal way again.

However, a single analogue vinyl record has very limited capacity to store music in, and a DJ has to prepare a lot of vinyl records in every event, and the records are likely to cause the DJ inconvenience due to the large size and heavy weight. Moreover, conventional vinyl records are prone to be damaged when they are manually moved relative to the turntable. Compact disks have larger capacity, and are smaller in size and more convenient to use than conventional vinyl records.

Therefore, various types of audio signal players are developed for DJ to play CD and produce special audio effects.

Referring to FIGS. 5 and 6, a common conventional audio signal player 6 includes:

a hollow housing 61, which has a holding room 611 therein;

a playing mechanism 62, which is held in the holding room 611 of the housing 61, and includes a circuit unit 621, and a reading unit 622 electrically connected to the circuit unit 621 for reading data from a record with;

a control mechanism 63, which is electrically connected to the playing mechanism 62, and includes a turntable unit 64, an actuating unit 65, and a signal reading unit 66 held in the holding room 611 of the housing 61; the turntable unit 64 being arranged on top of the housing 61 and capable of turning relative to the housing 61; the actuating unit 65 being held in the holding room 611 of the housing 61 for turning the turntable unit 64 with;

the turntable unit 64 including a first turntable 641, a second turntable 642 above the first turntable 641, and a coupling disk 643, which is arranged between the first and the second turntables 641 and 642, and connected to the first and the second turntables 641 and 642 in a separable manner;

the actuating unit 65 including a shaft 651, a first electromagnetic seat 652 secured around the shaft 651, and a second electromagnetic seat 653, which is positioned around the first electromagnetic seat 652, and used for causing the shaft 651 to turn; the shaft 651 being passed through the housing 61, and connected to the turntable unit 64 for causing the turntable unit 64 to turn with it;

the signal reading unit 66 including a first support seat 661, a first light blocking plate 662, a first photointerrupter 663, a second light blocking plate 664, and a second first photointerrupter 665; the first support seat 661 being arranged under the actuating unit 65; the first light blocking plate 662 being going to turn at the same way as the first turntable 641;

the first photointerrupter 663 being secured above the first support seat 661 for reading signals from the first light blocking plate 662; the second light blocking plate 664 being secured on a lower end of the shaft 651;

the second photointerrupter 665 being secured at a lower portion of the first support seat 661 for reading signals from the second light blocking plate 664; the signals acquired by the first and the second photointerrupters 663 and 665 being sent to the circuit unit 621 of the playing mechanism 62;

the playing mechanism 62 being going to play music in the normal way while the first and the second turntables 641 and 642 are turning in the same way; the playing mechanism 62 being going to play music and produce special audio effects while the first and the second turntables 641 and 642 are turning in different ways.

### SUMMARY OF THE INVENTION

It is a main object of the present invention to provide a digital audio signal player whose sensing mechanism used for acquiring the turning speed of the turntable unit is different from conventional sensing mechanisms of audio signal players.

The player of the invention includes a turntable unit, an actuating unit for the turntable unit, a circuit board arranged under the turntable unit, a magnet on an edge of a bottom of the turntable unit, an annular magnetism sensing plate on an upper side of the circuit board to face and sense the magnet, a light blocking plate secured on a shaft of the actuating unit, and a photointerrupters to sense the light blocking plate. The turning speed of the turntable unit is acquired by means of the magnetism sensing plate and the induction magnet while the turntable unit's turning direction is acquired by means of the photointerrupters and the light blocking plate. And, in a second embodiment, a light sensing plate and a reflection sensor is used for acquiring the turning speed of the turntable unit instead of the magnetism sensing plate and the induction magnet.

### BRIEF DESCRIPTION OF THE DRAWINGS

The present invention will be better understood by referring to the accompanying drawings, wherein:

FIG. 1 is a sectional view of the first embodiment according to the present invention,

FIG. 2 is an exploded perspective view of the first embodiment,

FIG. 3 is a partial section of the first embodiment,

FIG. 4 is an exploded perspective view of the second embodiment,

FIG. 5 is a sectional view of the conventional digital audio signal player as described in Background, and

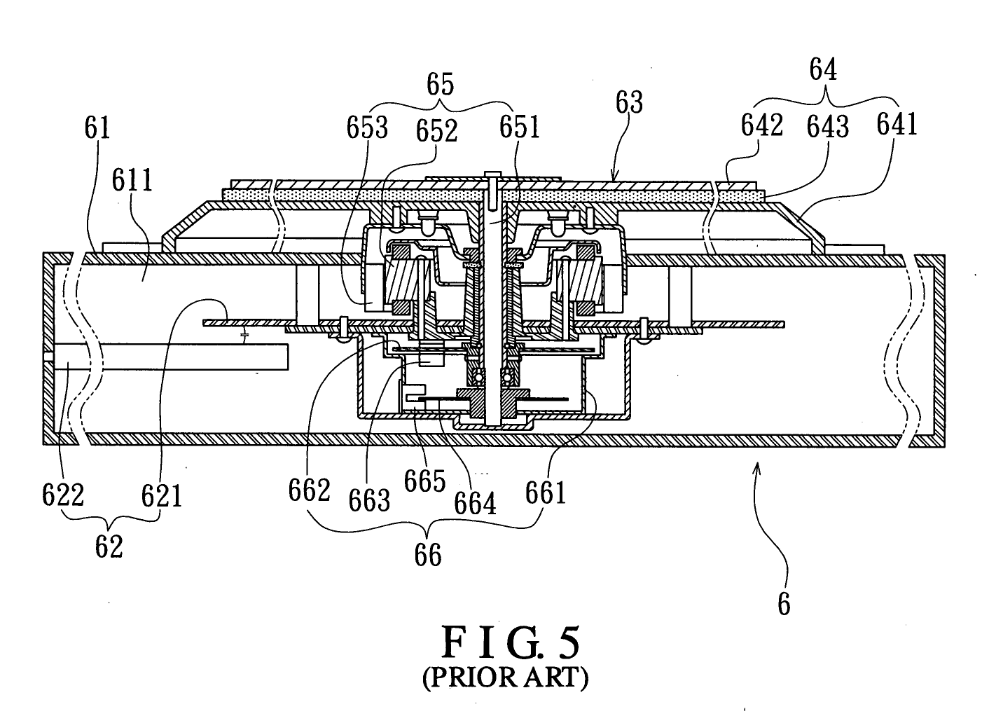

FIG. 6 is an exploded perspective view of the conventional digital audio signal player.

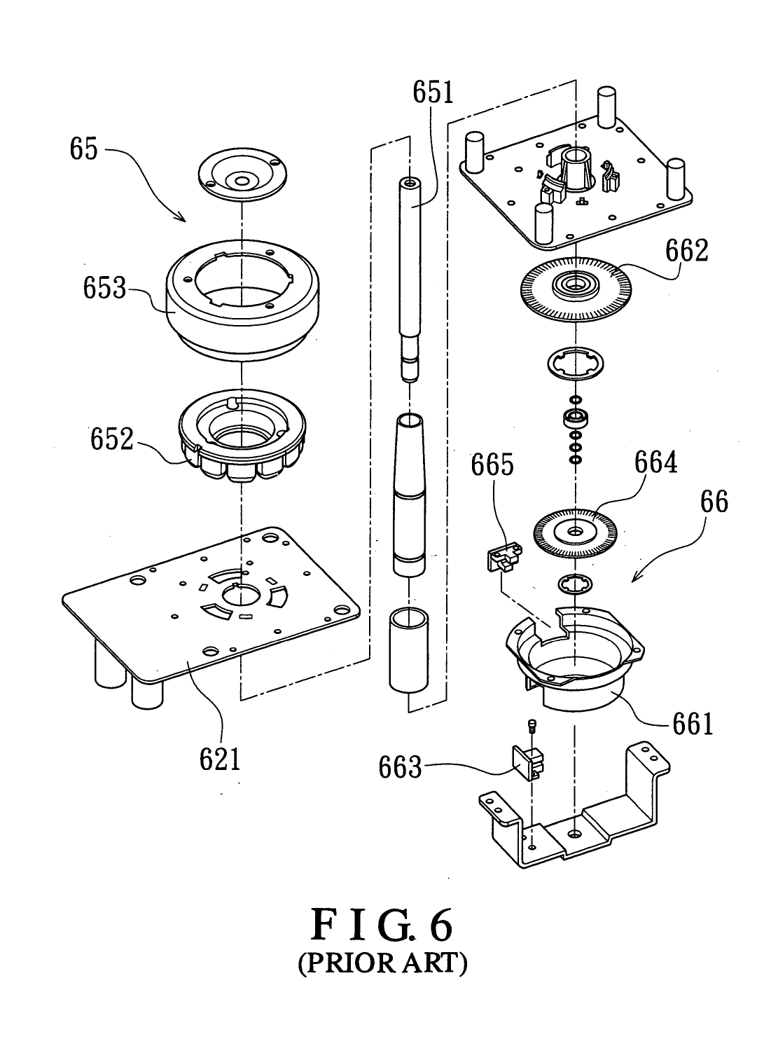

### DETAILED DESCRIPTION OF THE PREFERRED EMBODIMENTS

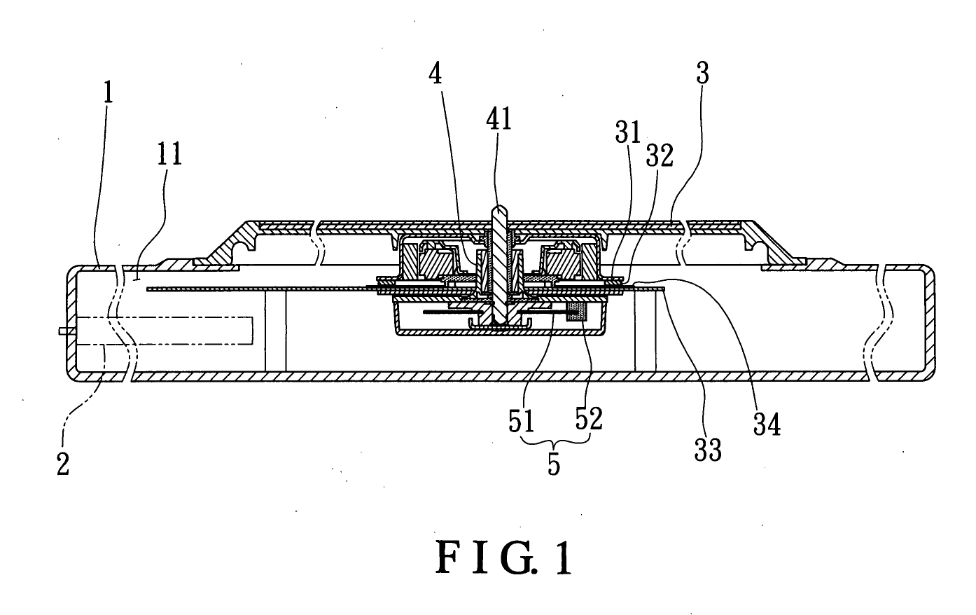

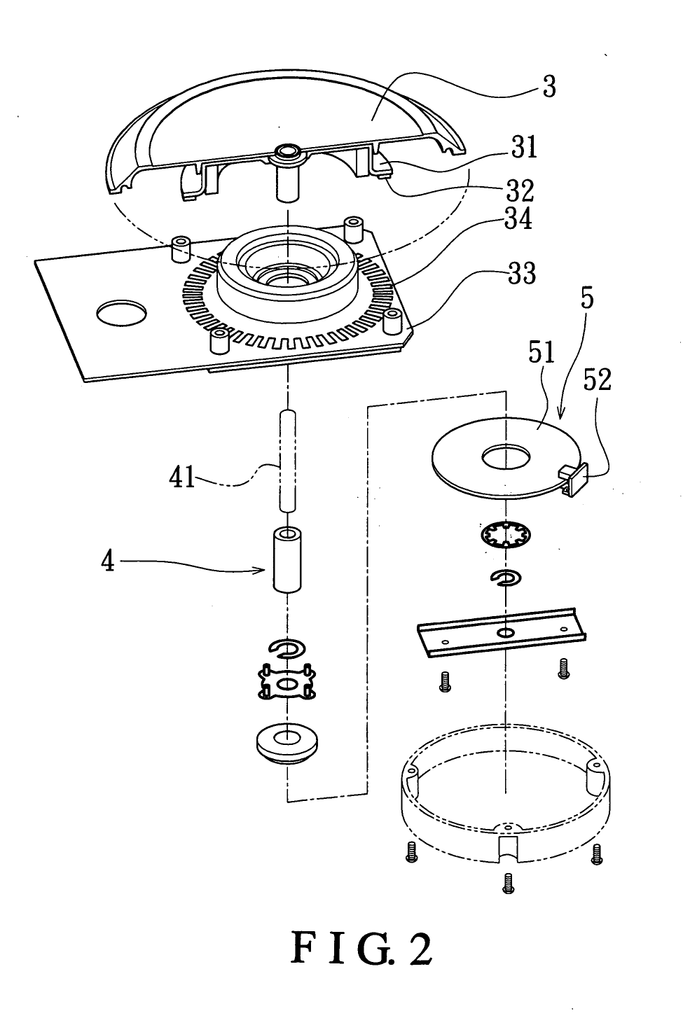

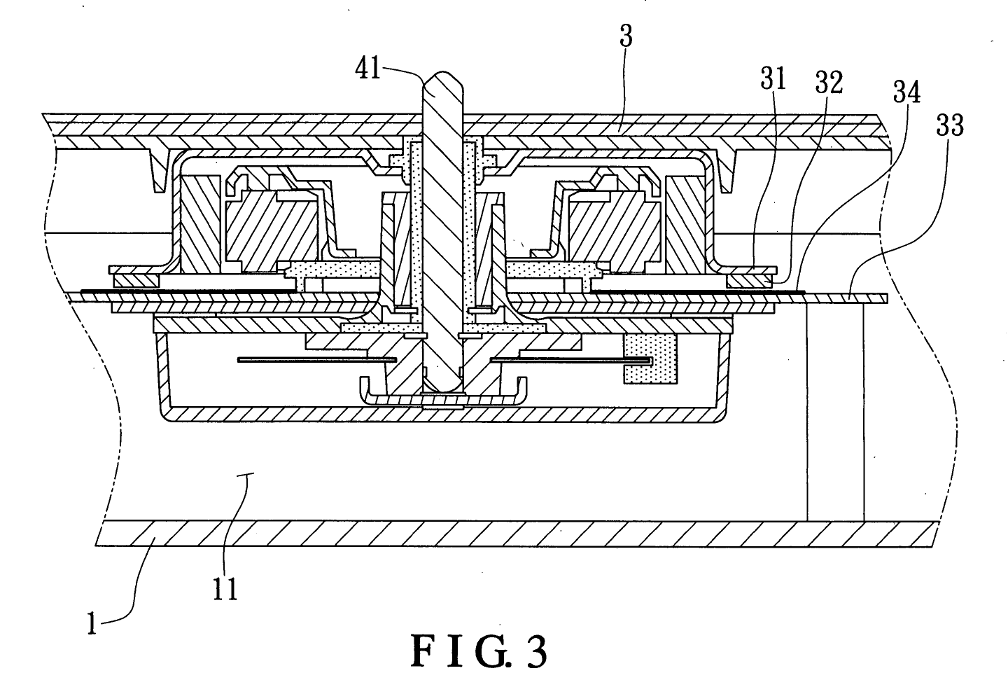

Referring to FIGS. 1 to 3, a first embodiment of a digital audio signal player is basically the same as the conventional digital audio signal player described in Background, including a hollow housing 1, a playing mechanism 2, a turntable unit 3, an actuating unit 4, and a signal reading unit 5.

The hollow housing 1 has a holding room 11 therein. The playing mechanism 2 is held in the holding room 11 of the housing 1. The turntable unit 3 is arranged on top of the housing 1. The actuating unit 4 includes a shaft 41, which is connected to a center of the turntable unit 3 for causing the turntable unit 3 to turn. The signal reading unit 5 includes a light blocking plate 51 secured on the shaft 41, and a photointerrupters 52 facing the light block plate 51 to sense the light blocking plate 51.

The first embodiment of an audio signal player further has a magnet seat 31, an induction magnet 32, and an annular magnetism sensing plate 34, which the conventional audio signal player doesn't have. The magnet seat 31 is secured on an annular edge of a lower side of the turntable unit 3 while the induction magnet 32 is secured on a lower side of the magnet seat 31. And, the annular magnetism sensing plate 34 is positioned on an upper side of a main circuit board 33 to face and sense the induction magnet 32, which main circuit board 33 is arranged under the turntable unit 3.

Therefore, the induction magnet 32 and the light blocking plate 51 of the signal reading unit 5 will turn together when the shaft 41 of the actuating unit 4 turns so as to cause the turntable unit 3 to turn. Consequently, the turning speed of the turntable unit 3 can be acquired by means of the magnetism sensing plate 34 and the induction magnet 32. And, the turning direction of the turntable unit 3 can be acquired by means of the photointerrupters 52 and the light blocking plate 51.

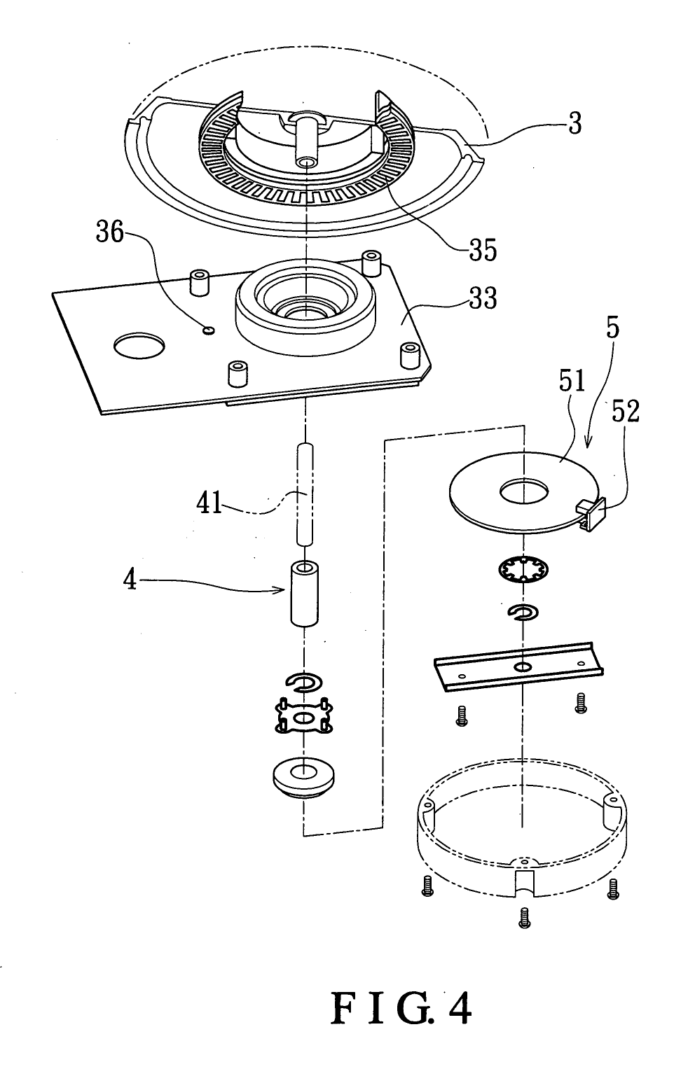

Referring to FIG. 4, in a second embodiment of an audio signal player of the invention, an annular light sensing plate 35 and a reflection sensor 36 is used instead of the magnet seat 31, the induction magnet 32, and the annular magnetism sensing plate 34 of the first embodiment. The annular light sensing plate 35 is secured on an annular edge of a lower side of the turntable unit 3 such that the annular light sensing plate 35 and the light blocking plate 51 of the signal reading unit 5 will turn together when the shaft 41 of the actuating unit 4 turns so as to cause the turntable unit 3 to turn. And, the reflection sensor 36 is positioned on an upper side of the main circuit board 33, which is arranged under the turntable unit 3, to face and sense the annular light sensing plate 35. Consequently, the turning speed of the turntable unit 3 can be acquired by means of the annular light sensing plate 35 and the reflection sensor 36. And, the turning direction of the turntable unit 3 can be acquired by means of the photointerrupters 52 and the light blocking plate 51.

From the above description, it can be understood that according to the present invention, the turning direction of the turntable unit is acquired by means of the photointerrupters and the light blocking plate while the turning speed of the turntable unit is acquired by means of both the annular light sensing plate and the reflection light sensor (or by means of both the annular light sensing plate and the reflection sensor). Therefore, consumers are provided with two additional choices.

What is claimed is:

1. A digital audio signal player, comprising
a hollow housing;
a playing mechanism held in the hollow housing;
a turntable unit arranged on an upper side of the hollow housing;
an actuating unit held in the hollow housing; the actuating unit including a shaft, which is connected to a center of the turntable unit for causing the turntable unit to turn;
a signal reading unit in the hollow housing; the signal reading unit including a light blocking plate secured on the shaft of the actuating unit; the signal reading unit including a photointerrupters facing the light blocking plate to sense the light blocking plate;
a main circuit board arranged under the turntable unit;
a magnet seat secured on an annular edge of a lower side of the turntable unit;
an induction magnet, the induction magnet being secured on a lower side of the magnet seat such that the induction magnet and the light blocking plate of the signal reading unit will turn together when the shaft of the actuating unit turns so as to cause the turntable unit to turn; and
an annular magnetism sensing plate positioned on an upper side of the main circuit board to face and sense the induction magnet;
turning speed of the turntable unit being acquired by means of the magnetism sensing plate and the induction magnet; turning direction of the turntable unit being acquired by means of the photointerrupters and the light blocking plate.

2. A digital audio signal player, comprising
a hollow housing;
a playing mechanism held in the hollow housing;
a turntable unit arranged on an upper side of the hollow housing;
an actuating unit held in the hollow housing; the actuating unit including a shaft, which is connected to a center of the turntable unit for causing the turntable unit to turn;
a signal reading unit in the hollow housing; the signal reading unit including a light blocking plate secured on the shaft of the actuating unit so as to turn with the shaft; the signal reading unit including a photointerrupters facing the light blocking plate to sense the light blocking plate;
a main circuit board arranged under the turntable unit;
an annular light sensing plate secured on an annular edge of a lower side of the turntable unit so as to turn with the turntable unit; and
a reflection sensor positioned on an upper side of the main circuit board;
turning speed of the turntable unit being acquired by means of the annular light sensing plate and the reflection sensor; turning direction of the turntable unit being acquired by means of the photointerrupters and the light blocking plate.
